(19) United States
(12) Patent Application Publication
(10) Pub. No.: US 2014/0014424 A1
(43) Pub. Date: Jan. 16, 2014

(54) Advanced propulsion engineless vehicle

(71) Applicant: Franz B. Boncodin, Long Beach, CA (US)

(72) Inventor: Franz B. Boncodin, Long Beach, CA (US)

(21) Appl. No.: 13/507,600

(22) Filed: Jul. 13, 2012

(51) Int. Cl. B60L 11/00

(52) U.S. Cl. CPC B60L 11/00
USPC 180/65.31

(57) ABSTRACT

The present “Advanced Propulsion Engineless Vehicle” invention is revolutionary land vehicle that operates without internal combustion engine that require fossil or other fuels to operate, nor uses “plug-in or hybrid” electric vehicle technology. It is powered by conventional off-the-shelve electric vehicle components and uses standard car batteries as primary or secondary power source. The invention's most revolutionary and important feature is its ability to automatically re-charge its batteries while the vehicle is in motion or not. This critical instantaneous re-charging ability is achieved through the deployment of redundant, radical on-board non-polluting power generating systems that may be used to re-charge batteries or used as primary power source to propel the vehicle. It utilizes a plurality of eco-friendly power generating/re-charging apparatuses allowing it to operate without practical driving limitations, capable of operating for thousands of miles plus, without stopping to re-charge, travelling at sustained, varied highway speeds, on almost all weather and road conditions, day or night, in full comfort, safety and style, permanently negating the use of plugged-in, hybrid vehicles or internal combustion engine technologies. The present invention is the most ideal, practical and cost effective non-ICE, non-plug or non-hybrid land vehicle that is simply called “Engineless”, the vehicle that uses the most common of prior art/components assembled in most simplest way but achieving history-making breakthroughs that will forever change the way people of the world drive, work and play while helping Planet Earth get back to pink health. The new engineless vehicle power source technologies, concepts and principles are also applicable for select air and water crafts as well. The present invention is a “back to basic” approach to car manufacturing without the trappings of new, ultra high tech contraptions or gizmos, use of ear-busting and polluting internal combustion engine and astronomical components and production costs. Simplicity is pure beauty, the essence of Advanced Propulsion Engineless Vehicle invention that will usher a new dawn of healthy civilizations, a very green, clean, cool and peaceful Planet Earth, now and for centuries to come.

### BACKGROUND OF THE INVENTION

1. Field of the Invention

The present invention relates to vehicles that do not employ the use of internal combustion engine and fossil fuels to operate. It is, or may be made to operate using select off-the-shelf electric vehicle components or prior arts such as DC motor, controller, contactor, accelerator, DC/DC converter, and batteries to name a few. Most importantly, the present invention employs new innovations and inventions never found in current electric vehicles such as a plurality of novel on-board power generator/battery charging apparatuses that may include, but not limited to thermoelectric charging devices, specially-designed and built-in fuel-less power generating system that may alternately be used as primary power source, or used to charge batteries while vehicle is in motion, the deployment of enhanced alternator and the inclusion of a radical “retractable rolling power generator” that can be deployed in times of primary power source interruption. In particular, the present engineless all electric vehicle invention/innovation using new or after-market-conversion chassis/body, batteries do not require re-charging or plugging in at home, office/factory or in charging stations. It's specially designed built-in, on board power generators/battery charging systems allows the engineless vehicle to operate continuously at sustained highway speeds, day or night on almost all types of road and weather conditions. It has no practical driving distance limitation as it is free from the traditional “mpg” (“miles per gallon”) limitations of ICE/fossil-fuel technology since it operates on the new “mpd” (“miles per day”) principle, a new standard, allowing it to operate without “recharging”, or for as long as the driver or drivers can drive safely, all without the use of conventional internal combustion engine, fossil fuel, hybrid or plug-in systems, features and advantages that are so distinct and different as compared with the best full electric or hybrid vehicles today.

The principles, concepts, technology, materials and method of construction of the propulsion system/apparatuses employed in the present invention, with certain modifications, are also applicable as alternate or primary power source/generator for crafts allowing it to operate with maximum range and efficiency with less use of solid or liquid fuels and reducing weight and space required to store and carry liquid or other forms of fuels.

2. Background of the Invention

With the advent of the off and on again electric vehicle programs in the United States and in other countries by small and large car companies including electric car hobbyists, the resurgence in electric vehicle interest is becoming more popular universally. Partly driven by high cost of fossil-fuels, fuel speculation, environmental concerns, bio-fuel issues, strained geo-political relations and perhaps government tax incentives, the electric vehicle program interest worldwide is alive and thriving, but not without pronounced growing pains. While advancements in the electric vehicle industry and components are improving, practical power source/battery issues continuously plague the industry. Present day best quality batteries for electric vehicles are still very expensive, bulky, heavy and require constant recharging. These limitations are proving to be the most serious obstacles that prevent the practical use of electric vehicles for all types of driving reasons, distance, comfort and safety. Because of these challenges, more especially the need for re-charging depleted batteries, charging stations/infrastructures in between homes, work places or in strategic locations may have to be constructed, posing another ‘unwanted consequence”. Charging or plugging in thousands, if not millions of electric vehicles into charging outlets at home, offices or public charging stations would be a huge and direct drain off power grids, which would necessitate the construction of additional new power plants just to supply electricity to re-charge batteries every day. This could become a very costly and polluting proposition, not to mention the delay or inconvenience of stopping to re-charge. It is also not very comforting to think that such batteries, which are the single and only power source of conventional electric vehicles, could suddenly go dead before reaching one's destination. These technical, logistical, mental and emotional fears does not give the driving public the encouragement, assurance and comfort to embrace the idea of fully shifting from traditional internal combustion engine (ICE) to full electric vehicle technology.

To mitigate some of the above issues, hybrid electric vehicles were re-introduced. The first hybrid was invented by Ferdinand Porsche in 1899. Like Porsche's invention, present-day hybrid vehicles are powered by a small internal combustion engine that requires fossil-fuels to propel the vehicle or to re-charge its batteries. Despite the many generations of knowledge in hybrid technology, no significant improvements were realized to make it an “ideal alternative”. The very limited driving range of present-day hybrids is not very encouraging and its price/costs are beyond the reach of people desiring to drive an “environment-friendly vehicle”. This approach is certainly not the ideal solution to having a practical, safe, clean, cost-effective and affordable electric vehicle for the masses.

Of note is the emphasis by electric vehicle and battery producing companies to concentrate in finding/producing the best batteries for electric vehicle. Little emphasis if any, is given to research and development on how to re-charge dozens of batteries used by electric and hybrids while vehicle is motion or not, which is one of the main thrusts of the present invention. The problems of current electric vehicle industry, therefore, are philosophical, direction and approach on how to create ideal situations, innovations or inventions so as to improve or perfect electric vehicle technology and enhance the conditions that will allow it to truly flourish without unwanted after-effects or unwarranted cost escalations. These are the objectives and story of the present “Advanced Propulsion Engineless Vehicle” invention. Its philosophy, direction and approach, is not necessarily to find the best batteries that can be recharged after so many, or so few miles of driving, but to re-charge batteries while the vehicle is operating or not, using radical and novel on-board power generating/charging apparatuses or systems. This near-perpetual power sources and automatic cycle of re-charging batteries while being depleted by the vehicle in motion is the open secret that allows the present Advanced Propulsion Engineless Vehicle to operate continuously without stopping to re-charge and without having to resort to hybrid technology.

The entry of the present “Advanced Propulsion Engineless Vehicle” invention that focuses on utilizing a plurality of “on-board, built-in power generators to recharge batteries while in operation, or used as primary power source”, completely negates stopping and re-charging batteries as they get depleted. The shortcomings, limitations and challenges facing current electric vehicle and allied industries will be fully resolved by the above philosophy, approach, invention or innovations, thus, allowing “genuine engineless/electric vehicle” full freedom to operate without practical driving limitations and without the bothersome exercise of stopping to re-charge spent batteries. The introduction of “on-board power generators/charging systems” may even trigger the reduction in cost/price of new battery acquisition or replacement costs, and may led to longer operating life. With this breakthrough, the world may now be able to proceed confidently and cost-effectively in moving the electric vehicle industry towards the right direction and endeavor that automotive industries throughout the world will now be inspired to populate all countries with zero-emission engineless vehicles that are not dependent on availability or not, of ICE, fossil-fuels and the inconvenience/cost of re-charging depleted batteries.

In fairness, humanity should give credit and appreciation for the generations of service, convenience, comfort and style provided by fossil-fuels and internal combustion engine, resources and inventions that helped move civilization from the crude method of transport technologies to modern conveyances of today. But as in nature, the cycle of life continues; the old fades away to give way to the new; this is the story of the venerable ICE and the entry of the new and radical Engineless Vehicle technology. Fossil-fuels will be here to stay, but may not necessarily be for fueling land, water or air transport in the foreseeable future.

3. Description of Prior Arts as Compared with the Present Invention

Current electric vehicles employ similar components, but not using new innovations/inventions or components found in the present invention. Current electric vehicles may be classified as: (1) full electric, or (2) hybrid types. Full electric vehicles do not use internal combustion engine; hybrids do plus sets of batteries. Both are plugged-in electric vehicles or re-charged using a small internal combustion engine while vehicle engine is running. Chassis, bodies and components of current electric vehicles may be new manufacture or after-market conversions. Electric vehicle hobbyists use conversion kits that are readily available in the market. With certain exception, current electric vehicle body shape design and construction remains traditional and bulky. To save on weight, height and length, some models that use new chassis and bodies attempt to make them lighter and less bulky, but may also compromise structural integrity and safety.

Like current electric vehicles, the present invention uses certain components that are readily available in the market. But unlike current electric vehicles, the present invention does not require an internal combustion engine, plugging-in, or use of charging outlets or stations. Unlike current electric and hybrid vehicles, the present engineless vehicle invention employs the use of novel, on-board, multi-power generating/charging systems that continuously replenishes whatever power is used by the battery to power the vehicle from stationary position, during acceleration, slowing down, stopping or reversing. Unlike current electric vehicles, the present invention's on-board power system my also be used as the main power source to power the vehicle.

In summary, some of very distinct differences between current electric vehicles and the present “Advanced Propulsion Engineless Vehicle” invention are; (1) revolutionary built-in multi-power generator/battery charging systems; (2) equipped with revolutionary on-board redundant primary, secondary and emergency power sources; (3) automatically and constantly replenishes used power from batteries while the vehicle is in motion; (4) does not require charging outlets or stations; (5) ability to operate without practical driving limitation; (6) displays very sleek, aerodynamic body design and other functional features; (7) employs built-in center hydraulic apparatus for easy tire or under belly service/maintenance; (8) employs front and rear sensors, safety camera, rear portable communications panel for directional, safety or emergency purposes; (9) sealed underbelly for additional aerodynamic advantage; (10) retractable emergency urinal under driver's seat; (11) features sound and visual technologies for the hearing and eyes-impaired pedestrian or drivers. These radical features, characteristics, appearance innovations/inventions are not found even in the most-advanced electric or hybrid vehicles on the road or showrooms today.

### DESCRIPTION OF DRAWINGS

Other aspects, advantages and uniqueness of the present invention shall become apparent after review of the following description when viewed in the light of the accompanying drawings or illustrations, wherein:

FIG. 1 Drawing—is a side view representation of the radical engineless vehicle straight lines and shape, sporting a very thin front/hood designed to sharply puncture the air/wind with minimal drag or resistance with its very sleek front that smoothly extends to the vehicle's body and rear, including partially shielding rear wheels and sealed underbelly of the vehicle to achieve a most aerodynamic and practical body design, and displaying bold color appearances to easily capture pedestrian and vehicular traffic attention in accordance with the exemplary embodiment of the present invention:

FIG. 1-B Drawing is a back view illustration of the present invention showing standard rear lights requirements, including novel audio, visual safety features, sensors, rear backing up camera, detachable pre-programmed safety/communication electronic panels and outline of sealed vehicle underbelly to minimize bottom drag while vehicle is in motion in accordance with the exemplary embodiment of the present invention.

FIG. 2 Drawing is a top view presentation of a typical engineless vehicle strip down chassis showing basic frame where structural supports be mounted, including spring assembly, sleeves for body attachments, outline of body envelop, plus front and rear “accident crumple zones” designed to absorb front or rear impacts complemented by four cab roll bars (not shown), and a couple of front battery holders in accordance with the exemplary embodiment of the present invention

FIG. 3 Drawing is a top view diagrammatic illustration of the present invention chassis where a plurality of batteries that are strategically located in the rear, mid section and front hood section to equally distribute weights throughout the vehicle body in accordance with the exemplary embodiment of the present invention:

FIG. 4 Drawing—is a top view illustration of the present invention chassis where major electrical, electronics, batteries, multiple power generating units, power control, management, safety apparatuses, retractable rolling power generator, climate system, on-board power generating/charging systems and emergency retractable/portable urinal device are positioned in accordance with the exemplary embodiment of the present invention:

FIG. 5 Drawing—is a top view drawing of the present invention chassis showing how major electrical, electronics, batteries, power, control, management, climate control, safety apparatus, redundant power sources and on-board power generating/charging systems are linked in series to ensure safe and efficient systems operation in accordance with the exemplary embodiment of the present invention:

FIG. 5-A Drawing is a top view drawing of the present invention chassis showing enlarged details on how a plurality of dynamos, shaft, pulleys, and small wheel are positioned in the vehicle in accordance with the exemplary embodiment of the present invention:

FIG. 5-B Drawing is a top view drawing of the present invention chassis showing one of several variations on how a single or plurality of dynamos may be installed next to a tire in accordance with the exemplary embodiment of the present invention:

FIG. 6 Drawing is Back View section drawing of a secondary, retractable rolling dynamo power system in accordance with the exemplary embodiment of the present invention:

FIG. 6-A Drawing is a Back View Drawing illustrating the housing or casing of the retractable rolling dynamo power system showing partially hidden dual rubber wheels in accordance with the exemplary embodiment of the present invention:

FIG. 6-B Drawing is a Front View of the housing or casing of the retractable rolling dynamo power system, which housing or casing is surrounded with thick, heavy-duty rubber linings in accordance with the exemplary embodiment of the present invention:

FIG. 6-C Drawing is a Bottom View of the housing or casing of the retractable rolling dynamo power system, which housing or casing bottom is sealed in accordance with the exemplary embodiment of the present invention:

FIG. 6-D drawing is a Side View presentation of the retractable rolling dynamo shown how it is positioned against surface levels when retracted in accordance with the exemplary embodiment of the present invention:

FIG. 7 Drawing is a Side View presentation of the present invention body shape displaying a retractable center hydraulic (jack) apparatus to facilitate tire change, under-belly maintenance or, to change direction by pushing the front or rear of vehicle to the desired trip direction in accordance with the exemplary embodiment of the present invention:

FIG. 8 Drawing is a Side View illustration of the present invention showing a deployed tertiary retractable rolling power generator in accordance with the exemplary embodiment of the present invention;

FIG. 9 Drawing is a Side View illustration of a 4-door version of the present invention showing the use of the chassis platform, the same sleek front hood and very aerodynamic body design in accordance with the exemplary embodiment of the present invention.

FIG. 10 Drawing is a Perspective View of a propeller-driven airplane showing how the advanced propulsion system (dynamo power generators) used in the present invention may be employed and located in another novel application, as an alternate or primary power source for a particular airplane, which alternate power generator unit(s) may be located on top, under the front wings, over the roof near the rudder, or under the belly of the aircraft equipped with a pair or more external propellers in accordance with the exemplary embodiment of the present invention.

FIG. 11 Drawing is a Front View illustration of the advanced propulsion system employed in a propeller-driven airplane showing a cylindrical air-intake apparatus, completely protective by screen wires and a four-bladed high-performance wind-driven propeller positioned vertically inside the air-intake apparatus.

FIG. 12 Drawing is a Side View illustration of the advanced propulsion system (the “system”) employed in a propeller-driven airplane showing an enclosure housing four-bladed propeller equipped with a shaft, which one end is connected and fixed to an adaptor in the center of the propeller and the other end rest in a ball bearing-equipped support structure and where a plurality of pulley/belt assembly connected to the shaft that is connected to high-performance dynamos that generates power are presented. (Drawings 10, 11, & 12 were presented to highlight other important uses of the advanced propulsion power generation system (the “system”) employed by the present invention, (which in this example, is used in a propeller-driven aircraft using combustion engines fueled by fossil-fuels), with the following general propeller-driven airplane operating assumptions:

Shortly after the aircraft has taken off using its standard fossil-fueled combustion engine and reached the assigned cruising altitude, the speed of the airplane will cause the air-intake to rapidly absorb and pass-through very high velocity air/wind that will cause the propellers inside the air-intake units to rotate at very high speeds, causing the propeller shaft, pulley and dynamo shaft to rotate at very high “rpm”, generating electricity that is monitored in several gauges inside the pilot's cockpit. Once gauges confirms that “all systems are operational”, pilot deactivates the combustion engine that turns the external propellers and instantaneously activates the “system” that now directs newly generated power to the motors that turns the airplanes external propellers. The power generated by the high performance “system” takes over the function of the combustion engine by supplying sustained power to the motor of the external propellers, allowing the aircraft to continuously fly without using its combustion engine that consumes enormous amounts of polluting fossil-fuels.

Upon nearing the airplane's destination, the reverse is executed by the pilot. Prior to landing; pilot engages all combustion engines, which automatically disengages all “systems”, transferring power source from the “system” to the combustion engine, then performs landing procedures until the aircraft is safely landed and parked. Once fully perfected, the “system” may also be possible to safely land the aircraft, negotiate the runway and safely park.

The deployment of a “system” in the above particular example, (which could be as small as a two-seater airplane or big as jet-powered commercial passenger, cargo, military, relief, research, evacuation or other type-use aircrafts), could mean unquantifiable intangible advantages and economic benefits for the particular craft/industry, not to mention the great environmental help in not spewing tons of air pollution resulting from engines burning fossil-fuels high above the ground, and affording passengers and crew members of the airplane extremely quiet and comfortable flight while the “system” is in operation. The “system” will especially benefit the operator by not having to buy and carry enormous amounts of expensive, heavy, polluting and volatile aircraft fuels.

### DETAILED DESCRIPTION OF THE PREFERRED EMBODIMENTS

The preferred embodiments of the present invention will now be described in detail with the reference to accompanying drawings.

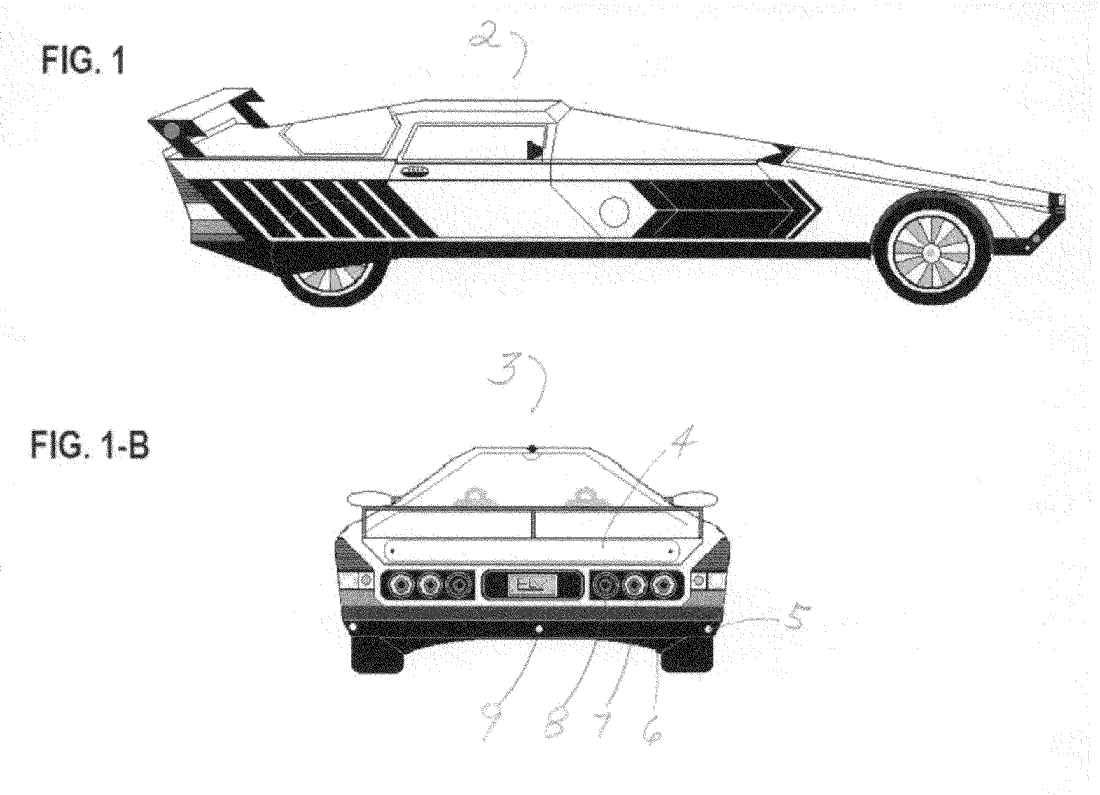

FIG. 1 Drawing—illustrates the preferred exemplary embodiment of a Side View presentation of “Advanced Propulsion Engineless Vehicle” invention generally indicated at 2, where the vehicle displays a very sleek front hood characterized by straight lines carried to the rear of the vehicle that is equipped with a very pronounced stabilizer, including partially covered rear wheels and sealed bottom (not shown), achieving a very aerodynamic body design intended to easily “puncture” the air with minimum drag or resistance while in operation, which body design includes visually and distinctive layering and markings for easy pedestrian and vehicular traffic attention or recognition.

FIG. 1-B Drawing—illustrates the preferred exemplary embodiment of the Back View presentation of “Advanced Propulsion Engineless Vehicle” invention generally indicated at 3, where it employs a portable vehicle electronic communications safety apparatus 4, side distance & motion sensor 5, sealed vehicle bottom 6, optional “dry ice smoke simulation” unit 7, an all-weather speaker system 8, and a rear camera apparatus that is automatically activated once vehicle is in reverse motion mode. The portable communications apparatus 4, side distance & sensors 5, rear speaker 8 and rear camera 9 all work simultaneously to enhance driver's ability and peripheral views to drive in reverse most safely while offering pedestrian or traffic behind the reversing vehicle maximum visual and audio warnings.

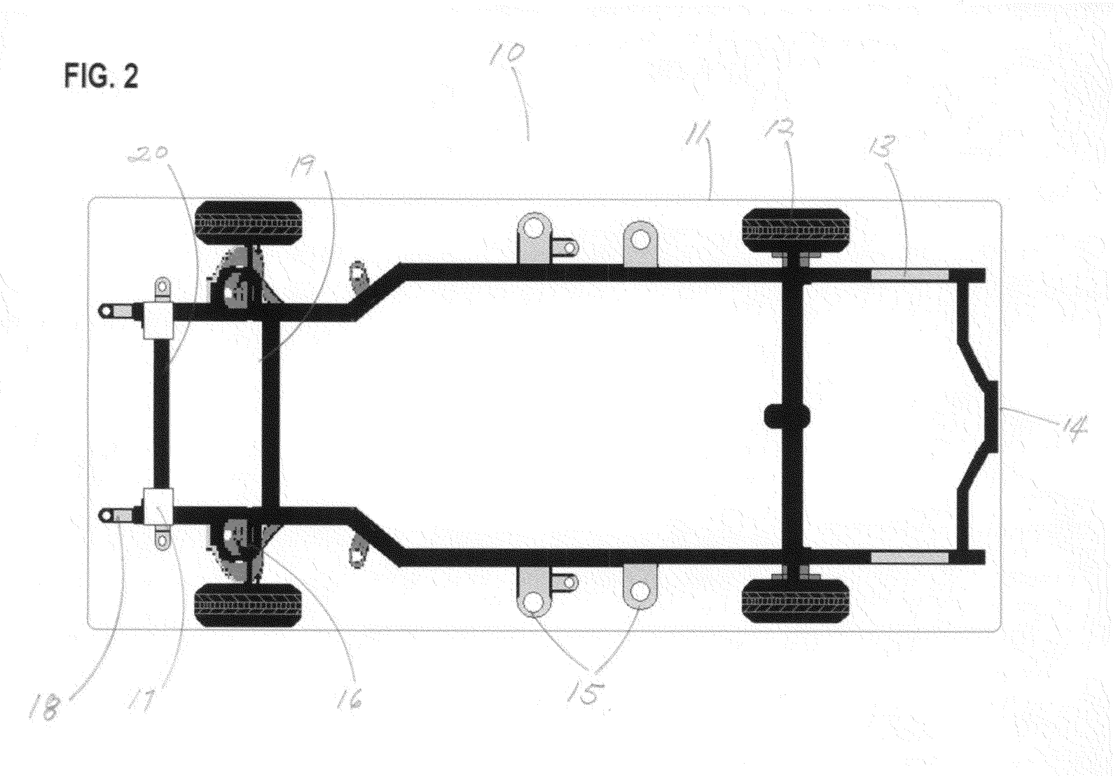

FIG. 2 Drawing illustrates the preferred exemplary embodiment of the Top View presentation of “Advanced Propulsion Engineless Vehicle” invention generally indicated at 10, where the outline of the vehicle body, 11, rear wheels 12, rear “crumple zone” 13 to absorb accident impacts aided by 14 rear collision chassis design, body attachment sleeves 15, front wheel, steering/braking/spring assembly 16, front hood battery rack 17, front chassis “crumple zone” 18, DC motor support 19 and front chassis structural support 20 are shown.

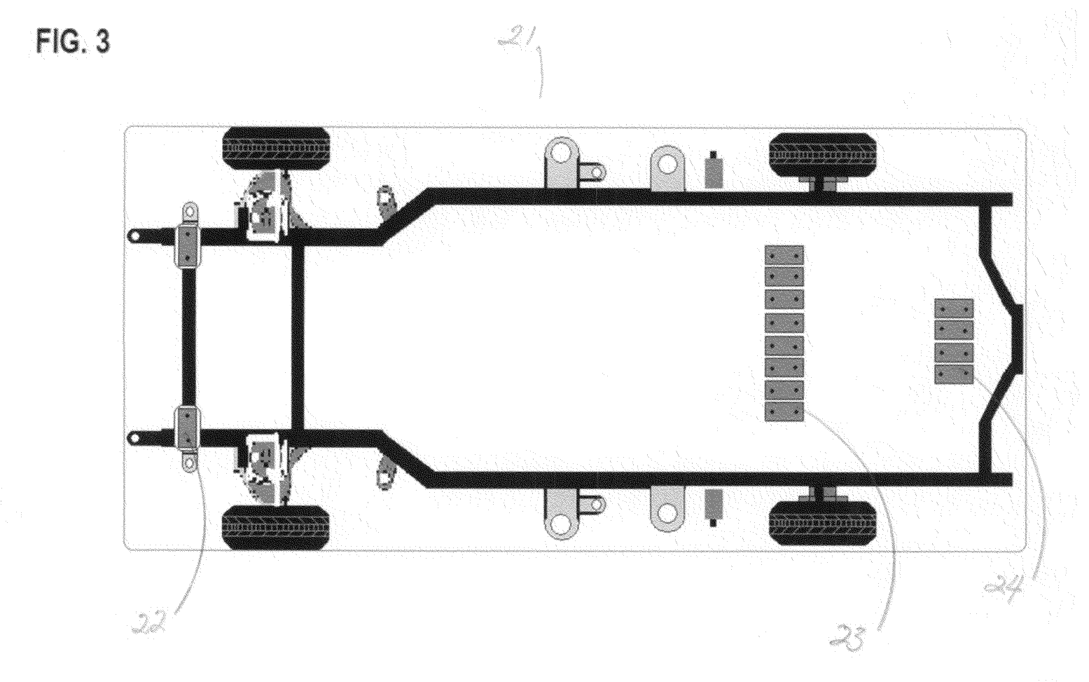

FIG. 3 Drawing—illustrates the preferred exemplary embodiment of a top View presentation of “Advanced Propulsion Engineless Vehicle” invention generally indicated at 21, where front dual car batteries 22 are situated, mid-section car batteries 23 are positioned, and tail end section car batteries 24 are strategically located so as to evenly distribute weights throughout the floor/body of the vehicle.

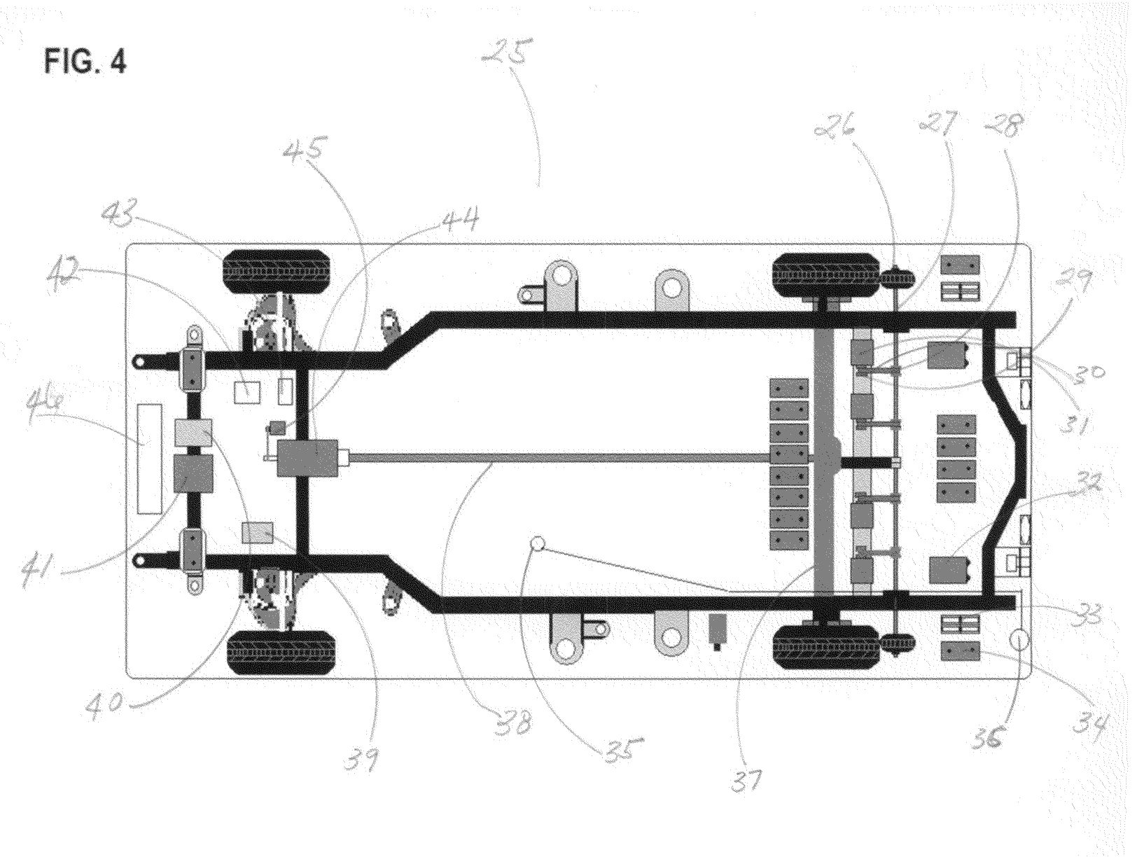

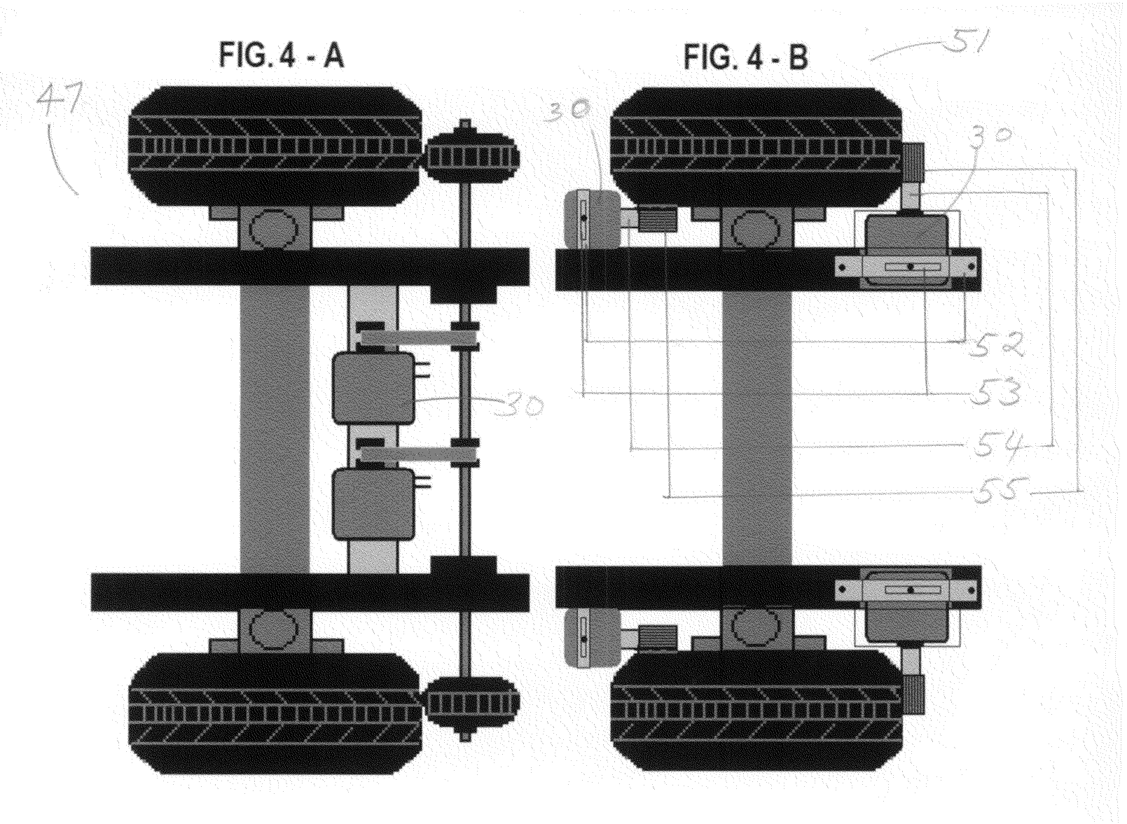

FIG. 4 Drawing—illustrates the preferred exemplary embodiment of a Top View presentation of “Advanced Propulsion Engineless Vehicle” invention generally indicated at 25, where small road-worthy rubber wheel 26 is positioned against the rear tire 12 of the vehicle, which small rubber wheel is equipped with a continuous shaft 27 that holds another small rubber wheel like 26 on its end, positioned against the other rear tire 12 of the vehicle, which shaft 27 is equipped with a plurality of belt adaptor 28, which belts adaptors are equipped with one or more commercially available engine belts 29 that are connected to a shaft 30, that is connected to a dynamo 31.

When the vehicle key is activated, the motion foot pedal is pressed down, all four vehicle tires starts to roll causing the two small rubber wheels that are “snugly resting” against the upper side of the big tires to also turn or rotate; as vehicle speed increases, the small wheels turns faster too causing the shaft attached to it, the belt and the dynamo's shaft to turn, thus generating raw power that can be used to re-charge depleting batteries, or, may be used as primary vehicle source of power while temporarily shutting off use of batteries for main power source. The action, therefore, of rotating vehicle tires causes the small rubber tires to rotate too and its “RPM” goes faster as the vehicle speed increases. The power output of the dynamos (which could be one or several units in a vehicle) is dependent solely on the rotation speed of the vehicle tires and the efficient transfer of that speed to the small rubber wheel(s) that turns the shaft, the belt, and turns the shaft connected to the dynamo coils, to generate electricity.

Additionally, a pair of radical, retractable rolling dynamos 32 located in the underbelly of the vehicle can be deployed in case of total primary & secondary (batteries & dynamo power generators respectively) power sources failure. Details of these retractable, rolling power generators are fully addressed in the succeeding pages.

Further, a third but experimental Thermoelectric Power Generator Charging (GPGC) apparatuses 33 & 34 were added as part of the new invention's redundant power sources/generators, which GPGC may become efficient battery chargers or may be used as alternate or primary power source of this and upcoming more advanced engineless or electric vehicles.

Because of the almost limitless operating/driving capability of the present invention, retractable hygienic emergency urinal(s) unit 35 is located under the driver's seat, and empties in a portable plastic tank 36 located in the back of the vehicle, a feature “borrowed” from the inventor's other approved inventions.

The vehicle rear differential 37 that is connected to a shaft 38 are presented including steering assembly 39, DC/DC converter 40, controller 41, contactor 42, fuse box 43, DC motor 44, alternator assembly 45 and climate control system 46 are positioned. Positioning/locations of different electrical/electronic components will vary according to the type, size, weight, dimension, configurations and amenities required by the particular vehicle.

FIG. 4-A Drawing—illustrates the preferred exemplary embodiment of a Top View presentation of “Advanced Propulsion Engineless Vehicle” invention generally indicated at 47, where the dynamo power generator apparatus 30 system details are enlarged for clearer viewing.

FIG. 4-B Drawing—illustrates the preferred exemplary embodiment of a Top View presentation of “Advanced Propulsion Engineless Vehicle” invention generally indicated at 51, where a couple of variations on the manner or method of installing one or more dynamos 30, against the upper side of a vehicle tire or against the inner side of the wheels. The dynamo 30 is tightly secured by a metal cradle 52, bolted unto the chassis, designed with rectangular opening and bolt 53 that allows the dynamo casing to be moved forward or backwards so that its shaft 54, equipped with heavy-duty rubber shoe 55 may be electronically or manually adjusted closer or farther from the tire.

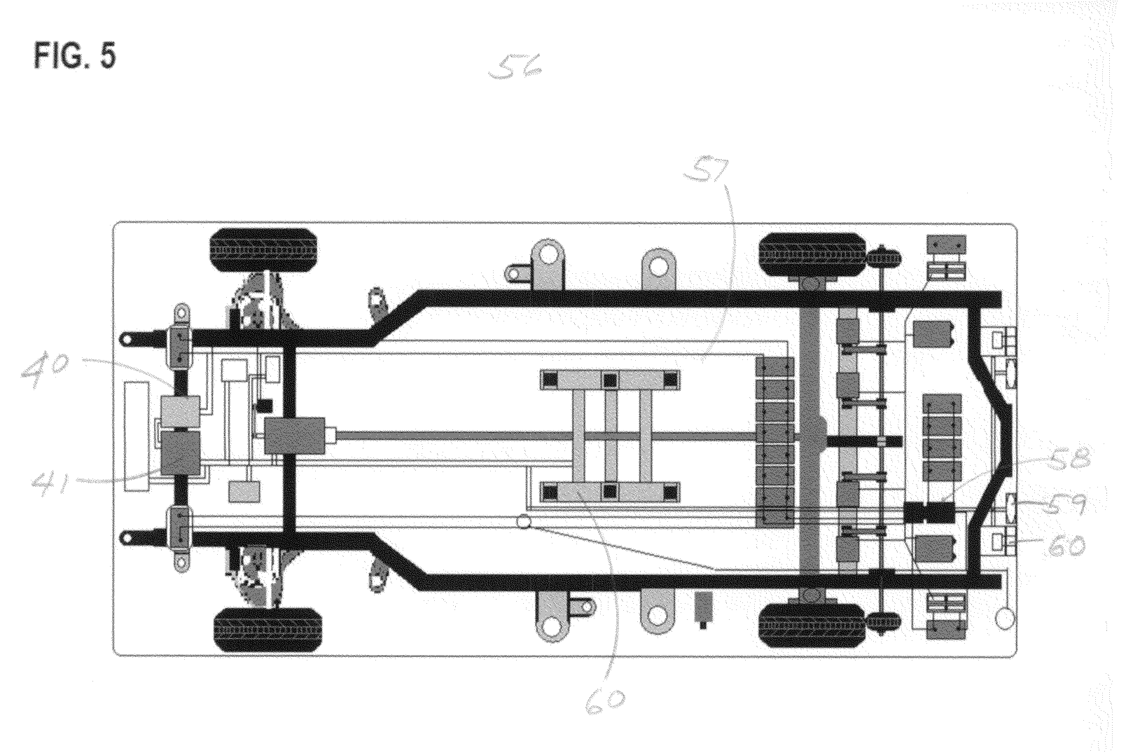

FIG. 5 Drawing—illustrates the preferred exemplary embodiment of a Top View presentation of “Advanced Propulsion Engineless Vehicle” invention generally indicated at 56, where all components, electrical/electronic systems, apparatuses, or parts are electrically connected in series by positive and negative wirings 57 that are first connected/anchored to battery-charging unit 58, that is connected to all batteries, dynamos and thermoelectric charging units which are connected to the DC/DC converter 40 that is connected to the controller 41 which receives/distributes, controls and manages fresh power throughout the electrical/electronic systems of the vehicle. A dual, all-weather speaker system 59 and dual dry ice/water/blower mechanism 60 are strategically located in the rear of the vehicle and can be manually or electronically activated individually or simultaneously to produce distinctive “canned ICE engine noise” accompanied by “dry ice smoke” blowing out of number 62, attracting or alerting the attention of physically-handicapped pedestrian or other drivers in the vicinity of busy road intersections or roadways. The utter silence of engineless vehicles in motion necessitated the design and installation of non-offensive, non-polluting but practical and effective visual and audio systems to make known the presence of a very silent but equally dangerous engineless vehicles in motion. Sounds and visuals are the best instruments that can be used to alert, warn or attract attention to dangers posed by engineless vehicles in operation. Sweet smell may also come into play when a driver pours in amounts of fragrance inside the dry ice/water solutions and blow them out through the “dry exhaust pipe” of the present invention.

Number 60 is an optional jack or hydraulic apparatus that can be operated manually or electrically to raise the vehicle above ground for tire changing, maintenance or car storage. When vehicle is in stationary position, Number 60 may also be used to change vehicle direction by pushing the vehicle front or rear to the desired

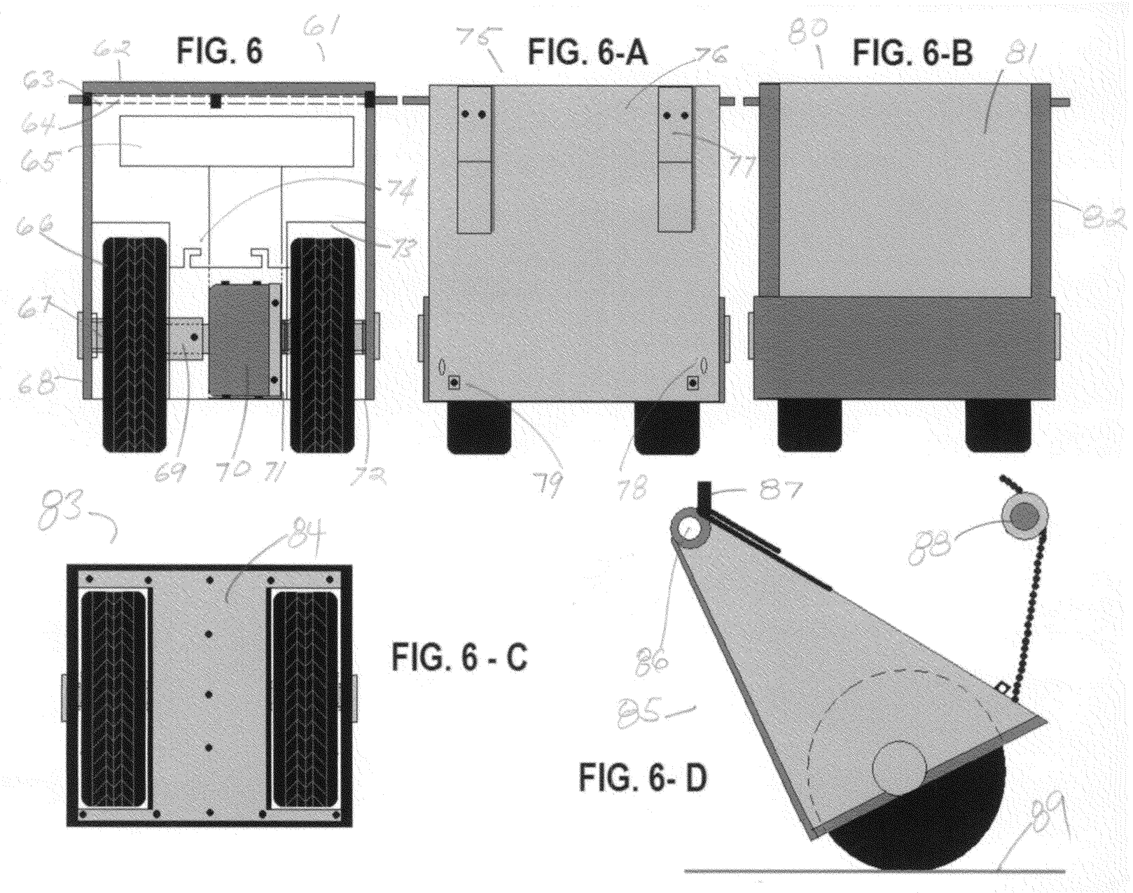

FIG. 6 Drawing—illustrates the preferred exemplary embodiment of a Back View presentation of Advanced Propulsion Engineless Vehicle “tertiary retractable rolling power generator” invention generally indicated at 61, where the rear cross-section of the retractable rolling dynamo power generator system 62 is presented comprising of a housing unit 63, equipped with a tubular shaft 64 attached to ball bearings (not shown) to allow easy shaft rotation, which extended shaft serves as suspension/anchor mechanism at the bottom of vehicle floor. The front inside part of the dynamo housing includes additional bracing 65, a set of road-worthy small rubber wheels 66 equipped with a short rotating shaft 67 that is housed and secured in a hole, bolt and nut on the lower side 68, of the dynamo housing with the other end of the wheel shaft is attached to a rotating shaft 69 that is connected to a dynamo 70, which dynamo base is bolted unto the steel bracing 65 while the dynamo's right end is securely fastened against a flat non-revolving plate 71 attached to the non-rolling side of the right small wheel, with the edge 72 of the dynamo housing is extended past the center line of the small wheel. Inside the dynamo housing unit, a secondary dynamo water-proofed enclosure 73 is constructed with dual vents 74, which secondary protective enclosure safeguards the dynamo apparatus from debris, liquids, mud, allow entry and exit of ambient air to cool the dynamo and preventing the rotating wheels from contaminating the dynamo.

In the event of power emergency while vehicle is in motion, the retractable rolling dynamo power generator system can be lowered from the belly of the vehicle via a manual or automated pulley system, resulting with the two small wheels to get in contact with road or ground surface causing it to roll and turning the dynamo shaft, the dynamo coil/system and generate electricity that is automatically directed to the vehicle battery charging unit, or in emergencies, directly send generated power to the DC/DC converter and to the controller and used as primary power source to sustain vehicle motion. The amount of power generated by this “tertiary” power generating system is dependent on the speed of the vehicle and “RPM” of small wheels that turns and rotates the dynamo shaft, turning the inside coils/mechanism of the dynamo causing it to generate electricity for vehicle use. Power output of this ‘tertiary” power generator is determined by the “RPM” of the wheels and by the manufacturers stated out or performance ratings.

FIG. 6-A Drawing—illustrates the preferred exemplary embodiment of a Back View illustration of Advanced Propulsion Engineless Vehicle tertiary retractable rolling power generator invention generally indicated at 75, where it displays the back side 76 of the external housing unit, where pair of a layered flat metal spring 77 are employed to regulate the upward and downward motion of the entire unit while in operation, which back side is equipped with locking mechanism 78 to secure the unit once raised, and pulley/chain hook up 79 used to bring down or raise the entire “tertiary” housing unit from the under-belly of the vehicle.

FIG. 6-B Drawing—illustrates the preferred exemplary embodiment of the Front View presentation of Advanced Propulsion Engineless Vehicle tertiary retractable rolling power generator invention generally indicated at 80, where its front side 81, is equipped and surrounded by heavy-duty rubber protection 82, against rocks and other debris while the apparatus is in motion.

FIG. 6-C Drawing—illustrates the preferred exemplary embodiment of a Bottom View presentation of Advanced Propulsion Engineless Vehicle tertiary retractable rolling power generator invention generally indicated at 83, where the dynamo's housing bottom is almost completely sealed with non-corrosive sheet metal 84 to block or minimize entry of debris, liquid, mud, insect, rodents or the like.

FIG. 6-D Drawing—illustrates the preferred exemplary embodiment of a Side View presentation of Advanced Propulsion Engineless Vehicle tertiary retractable rolling power generator invention generally indicated at 85, where it shows the hallow top installation hole 86, support base 87 for the double flat metal spring 77. Also shown are the pulley/chain 88 system, used to lower or raise the rolling power generation system so its wheels gets in contact with the road surface 89 to commence operation in generating electricity.

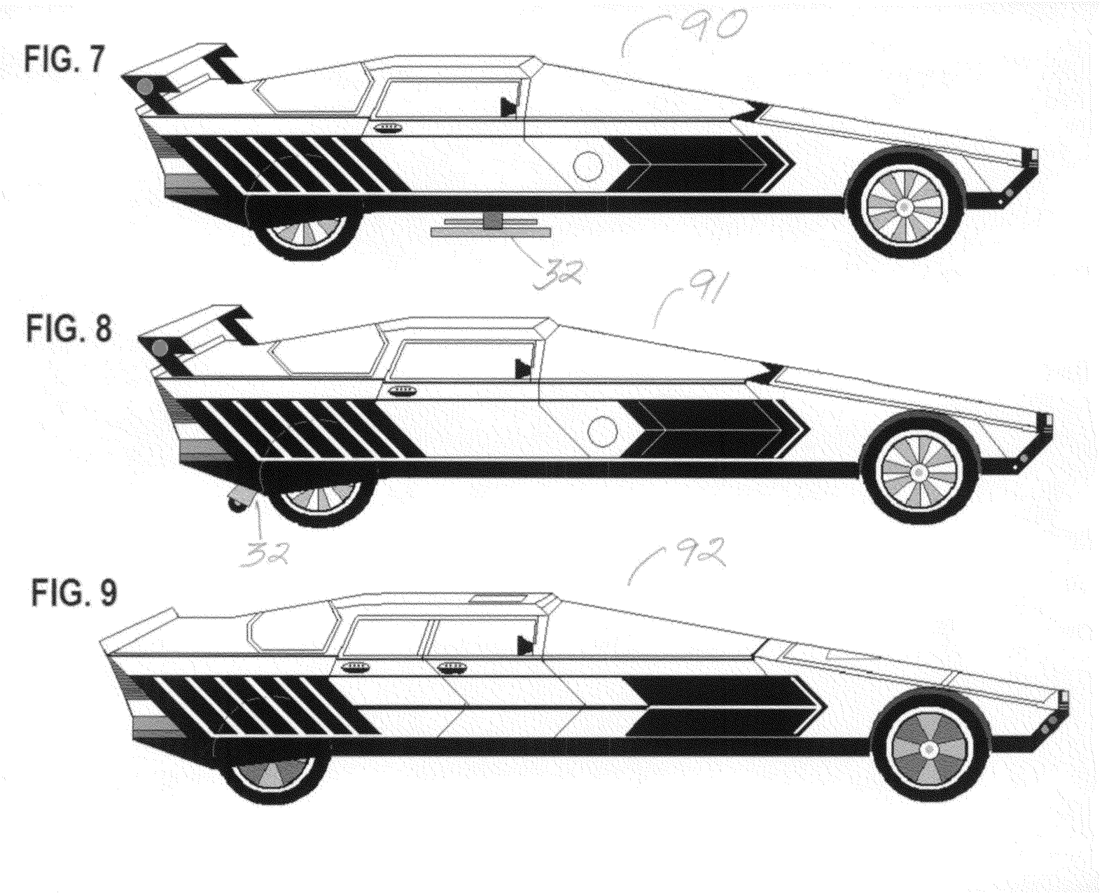

FIG. 7 Drawing—illustrates the preferred exemplary embodiment of a Side View presentation of “Advanced Propulsion Engineless Vehicle” invention generally indicated at 90, where the vehicle displays a retracted jack or hydraulic system 60 that can be used to elevate the vehicle for tire replacement or under belly maintenance.

FIG. 8 Drawing—illustrates the preferred exemplary embodiment of a Side View presentation of Advanced Propulsion Engineless Vehicle invention generally indicated at 91, where the vehicle illustrates a tertiary retracted rolling dynamo power generating system 32, which tertiary retractable rolling power generator may be positioned in any appropriate location under the floor of the vehicle.

FIG. 9 Drawing—illustrates the preferred exemplary embodiment of a Side View of Advanced Propulsion Engineless Vehicle” invention generally indicated at 92, where a four-door engineless vehicle model using generic chassis, body and aerodynamic design is presented. By using standardized platform, chassis and body design, the cost of mass-producing it can be effectively lowered, resulting in affordable selling price for the buying public.

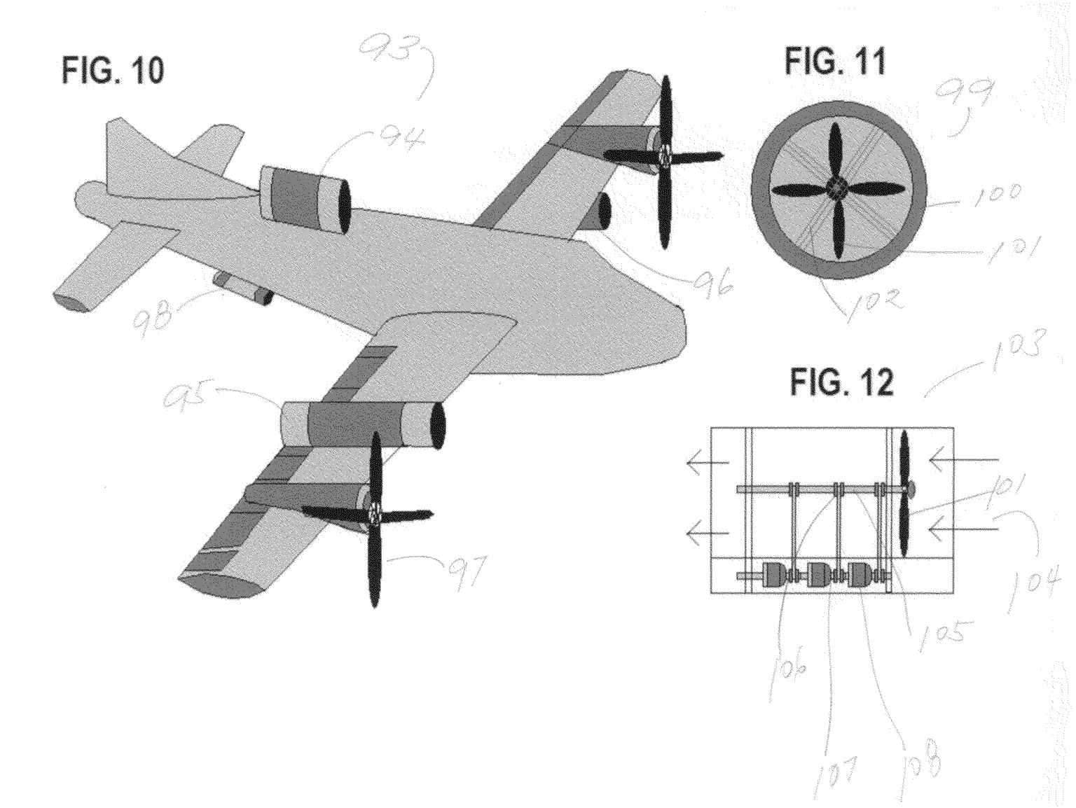

FIG. 10 Drawing—illustrates the preferred exemplary embodiment of a Perspective View of the present invention's novel power generating “system” generally indicated at 93, when the “system” is employed as an alternate or primary power source for an air conveyance, which in this example, is an engine/propeller-driven aircraft showing one of several ways where the “system” may be positioned on roof 94 of the aircraft, on top of the wing 95, under the wing 96 in the proximity of aircraft main propellers 97, or under the belly 98 of the aircraft.

FIG. 11 Drawing—illustrates the preferred exemplary embodiment of a Front View illustration of the present invention's novel power generating “system” as applied to an engine/propeller-driven aircraft generally indicated at 99, where a cylindrical air intake unit 100, a four-blade upright propeller 101 and protective screen wire 102 are presented;

FIG. 12 Drawing—illustrates the preferred exemplary embodiment of a Side View drawing of the present invention's novel power generating “system” as applied to an engine/propeller-driven aircraft generally indicated at 103, where the horizontal air-intake unit 100, strong air/wind currents 104 turns the propeller 101, that turns the propeller shaft 105, that turns the pulley/belt assemblies 106, causing the dynamo shaft 107 to rotate, allowing the dynamo 108 to generate power for aircraft use. The propeller, shafts and belts are secured inside the air-intake apparatus 100 while the dynamos 108 are, or can be positioned/insulated in the desired location(s), safely.

In addition to providing the world with economical, zero-emission, non-fossil fueled, non hybrid, non-plug, non-ICE and practically no-driving limitation engineless vehicles, one of the many objectives of the present invention are to simplify mass-production methods, reduce production costs, offer much lower selling price, recycle whole car bodies, lessen dumping of used car parts and strongly recommends the adoption of safe, ultra aerodynamic body design to ensure utmost car efficiency and practicality.

The foregoing description and applications of the preferred embodiment of the present invention has been presented for the purposes of illustrations in accordance of the provisions of the Patent Statutes. It is not intended to be exhaustive or limit the invention to the precise forms disclosed. The embodiment disclosed hereinabove were chosen in order to best illustrate the concepts and principles of the present invention and its practical application(s) to thereby enable those of ordinary skill in the art to best utilize the invention in various embodiments and with various modifications as suited to the particular use contemplated, as long as the principles or concepts described herein are not followed. This application is therefore intended to cover any variations, uses, modifications or adaptations of the invention using general principles or concepts.

Further this application is intended to cover such departures from the present disclosure as come within known or customary practice in the art to which this invention pertains. Thus, changes can be made in the above-described invention without departing from the intent and scope thereof. It is also intended that the scope of the present invention be defined by the claims appended thereto.

What is claimed is:

1. An “Advanced Propulsion Engineless Vehicle” absent of internal combustion engine or other types of engines that utilize fossil-fuels, bio-fuels, natural gas, additives, other liquid or solid fuels & substances operating;

2. An engineless vehicle, which body shape is characterized by straight lines forming a very sleek thin front hood, which straight lines extend to the rear of the vehicle, partially covering rear wheels, with sealed under belly to achieve a most aerodynamic and practical body design displaying by a very pronounced rear stabilizer in certain models;

3. A revolutionary vehicle without internal combustion engine, without hybrid or plug-in electric vehicle systems, but can operate without practical driving distance limitations it can travel continuously at sustained highways speeds, without stopping for thousands of miles and more, or for as long as the operator can drive safely to his/her destination;

4. A radical engineless vehicle that do not require stopping to plug and re-charge its batteries or fill up gas tank it does not have;

5. An engineless vehicle that employ the use of batteries as primary or alternate power source for initial motion, acceleration or reverse operation;

6. An engineless vehicle that utilizes a novel secondary source of power using on board dynamo power generating system, which system may be used as primary power source, holding the batteries in reserve or while being re-charge while the vehicle is in motion or not;

7. An amazing engineless vehicle that employs a tertiary, retractable, rolling power generating system that produces power once its wheels gets in contact with road or land surfaces;

8. A vehicle equipped with eco-friendly, redundant power generating systems that uses prior arts or off-the-shelve common components, which redundant power generating systems may be used to re-charge batteries while vehicle is in motion or not, or used as the primary electric sources to power the vehicle;

9. A vehicle which front section is equipped with built-in motion and distance sensors, front blind spots camera and a novel speaker/horn unit;

10. An engineless vehicle which rear end is equipped with built-in motion and distance sensors, a rear camera that automatically activates when vehicle is in reverse mode, a pair of outdoors all-weather speaker systems for audio alerts/warning, and a pair of dry ice/water/“smoke” blower mechanisms for visual and audio alert/warning devices, and emergency, retractable urinal(s) under the seat(s) of the vehicle;

11. A friendly vehicle equipped with rear portable electronic communications panel that can be used for alerting or warning pedestrians and drivers operating behind the vehicle, or call attention/attract others for assistance; equipped with required safety features, entertainment, climate-control, communications, navigations and a heat sensor-driven exhaust fan that activates inside the vehicle once indoors temperature reaches uncomfortable temperature levels while vehicle is parked in the open air.

12. A full size Advanced Propulsion Engineless Vehicle, which power systems principles, concepts, design, material and construction methods are applicable for select air and water crafts, allowing these water and air crafts to operate without practical distance limitation thus conserving fossil fuel, minimize use of engines and eliminating toxic emissions into the environment.

13. An engineless vehicle that is absolutely zero-emission vehicle, one that do not require smog test(s) for yearly registration renewal;

14. An engineless vehicle that can be designed and constructed as a race car capable of achieving speeds and durability rivaling ICE-equipped race cars, or produced as family, recreational, business and heavy transport vehicles.

15. A vehicle that can be equipped with commercial isotope heat source for high performance thermoelectric chips capable as vehicle primary power source;

16. An engineless vehicle invention that will simplify the manner of mass-production, car assembly and component costs so as to achieve lower selling price for the general public;

17. An engineless vehicle that will become the standard of the world; and,

18. An engineless vehicle that will usher a new generation, the “Clean Engineless Generation” starting now; it is also hoped and claimed that the present Advanced Engineless Vehicle invention in some small way, help reduce the reasons for making or having wars over fuel supplies/availability, and to make such, or other wars obsolete, forever.
